(19) United States
(12) Patent Application Publication
(10) Pub. No.: US 2004/0216584 A1
(43) Pub. Date: Nov. 4, 2004

(54) Method and device for assisting musical composition or game

(76) Inventor: Serge Audigane, Lire (FR)

Correspondence Address: YOUNG & THOMPSON, 745 SOUTH 23RD STREET 2ND FLOOR, ARLINGTON, VA, 22202

(21) Appl. No.: 10/480,138

(22) PCT Filed: Jun. 7, 2002
(86) PCT No.: PCT/FR02/01948

(30) Foreign Application Priority Data
Jun. 11, 2001 (FR) 01/07573

(51) Int. Cl. G09B 15/00

(52) U.S. Cl. 84/470 R

(57) ABSTRACT

Method for assisting musical composition for harmonic performance comprises inputting or selecting, on an instrument or a device associated with an instrument, a note corresponding to the tonality of the piece to be played, and the instrument or associated device locates or displays, on the basis of the inputted tonality note, a first range of notes, called melody notes and the instrument or associated device displays or locates selectively, on the basis of the inputted or selected tonality note and the melody note actuated within the authorized range of melody notes, a series of notes forming a chord corresponding to the actuated melody note.

The present invention relates to a process for helping with the composition or playing of music, to play in harmony any melody on an instrument, as well as an instrument and a device associated with an instrument for practicing the process.

Playing in harmony any melody with chords corresponding to each note of the melody, presupposes long practice and good musical knowledge. The same is true, to establish the accompaniment or accompaniments corresponding to any melody when it is desired to play several instruments simultaneously. Because of these difficulties, improvisation of musical pieces including a melody and an accompaniment is at present the field of skilled musicians.

There is known from German patent DE-A-4.002.361 a process which consists, beginning with a keynote, in displaying the corresponding chords as a function of the major mode, the minor mode or another selected one. However, it is not possible to display the notes of the melody that is authorized, then to display in the next instance, from an authorized melody note, the corresponding chord as a function of the selected melody note. Thus, in a first embodiment, there is provided a short rule constituted by a panel carrying a plurality of series of notes in the form of columns. This panel is movable within a housing provided with display windows. Thus, as a function of the keynote selected by displacement of the panel within the housing, there are displayed the major and minor chords. This same principle is followed in a second device constituted by four rotatable discs mounted on a common support. The disc relating to the choice of the common support. The disc relating to the choice of the keynote can be coupled by moving to the other discs so as to cause to appear, through the windows, the corresponding chords for each of the discs, each disc being associated with a predetermined mode. Such a process however does not permit establishing a direct connection between the note of the melody played and the corresponding chord.

An object of the present invention is to provide a process whose practice, on an instrument or a device associated with an instrument, permits a beginning player to play in harmony any musical piece including a melody of his choice and the corresponding accompaniment, without any theoretical knowledge of chords.

Another object of the present invention is to provide a process whose practice permits a group of players, such as an orchestra, to identify instantaneously, from any improvised melody, the corresponding accompaniment.

Another object of the present invention is to provide an instrument whose design permits a beginning player to improvise pieces including any melody and the corresponding accompaniment.

Another object of the present invention is to provide a device associated with an instrument whose design permits the user of the instrument to identify without effort the accompaniment corresponding to the improved melody which he plays, this accompaniment being adapted to be played on the instrument itself or on other instruments.

To this end, the invention has for its object a process for helping in the composition or playing of music, to play in harmony any melody on an instrument, characterized in that there is taken or selected, on the instrument or on a device associated with the instrument, a note corresponding to the key of the piece to be played, in that the instrument or the associated device marks or displays, as a function of the note of the selected key, a first range of notes, called melody notes, corresponding to the range permitted to establish a melody and in that the instrument or the associated device displays or marks selectively, as a function of the melody actuated within the range of notes of the permitted melody, a series of notes forming a chord corresponding to the actuated melody note within the permitted range of notes.

The practice of such a process on an instrument or a device associated with an instrument by a beginning player, permits the latter to completely improvise a melody provided he selects the notes of the melody from the permitted range of notes and to display automatically the chord corresponding to each note of the actuated melody. The player can thus without any thought play a melody in harmony by associating with it the corresponding accompaniment.

According to a preferred embodiment of the process, there is taken or selected moreover the mode such as the minor or major mode or the like, of the piece to be played, and in that the instrument or the associated device marks or displays selectively as a function of the keynote and the taken or selected mode, the range of permitted melody notes and as a function of the keynote, of the selected mode and of the actuated melody note the corresponding chord.

The invention also has for its object an instrument, particularly for the practice of the process of the mentioned type, characterized in that it comprises means for taking or selecting a keynote and if desired the minor, major or other mode, first means for picking out or selectively displaying that are actuable, from the selected keynote and if desired from the selected mode, to indicate visually to the user the permitted range of melody notes, and second means for picking out or selectively displaying, actuable by actuation of a selected melody note within the range of permitted melody notes, to indicate to the user, upon each actuation of a melody note within the range of permitted notes, the notes of the corresponding chord.

The invention also has for its object a device associated with an instrument particularly for the practice of a process of the mentioned type, characterized in that it comprises means for picking out or selecting a keynote and if desired the minor, major or other mode, first means for marking or predetermined display as a function of the taken or selected keynote and if desired of the selected mode, to indicate visually to the user a range of permitted melody notes on the instrument and second means for marking or selective display, actuable by actuation of a selected melody note within the range of permitted notes, to indicate to the user the chord corresponding to each melody note played.

The invention will be better understood from a reading of the following description of embodiments, with reference to the accompanying drawings, in which:

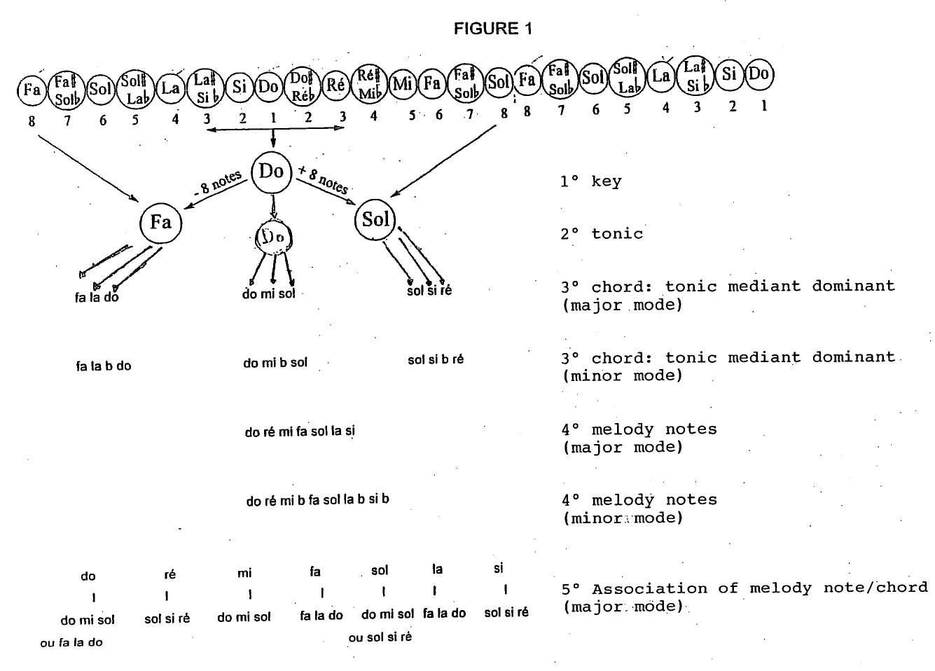

FIG. 1 shows schematically the determination, from a keynote, of the chords and corresponding melody notes from the chromatic scale;

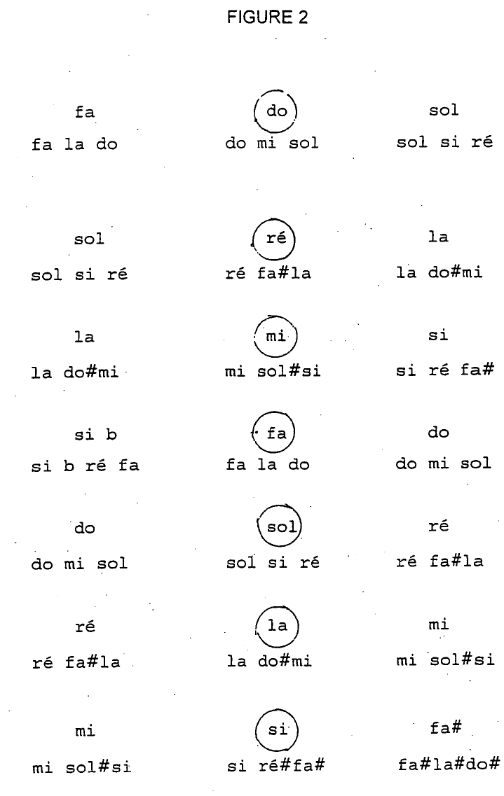

FIG. 2 shows the different chords that can be obtained for a major mode from the process shown in FIG. 1;

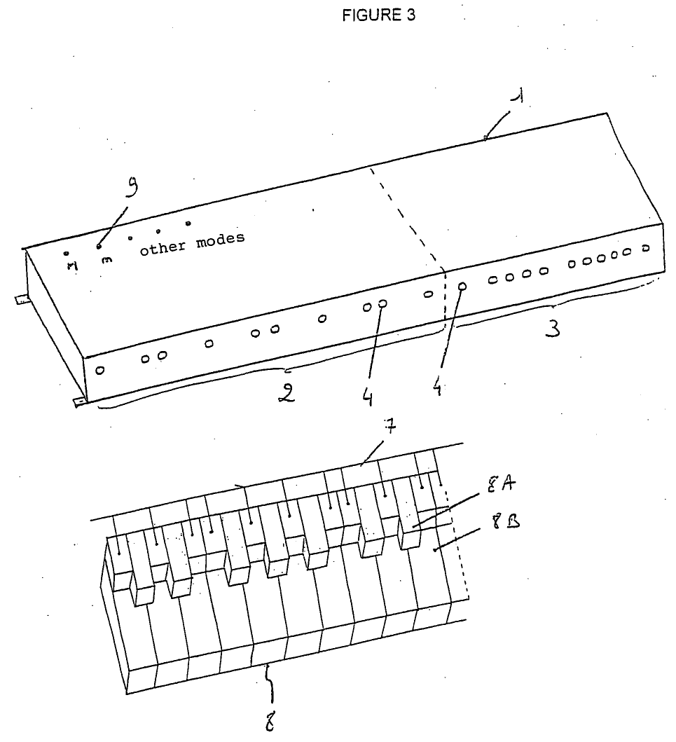

FIG. 3 shows a schematic perspective view of the keyboard of a piano provided with a device for compensating the differences in level between keys and an associated support adapted to be positioned on said keyboard;

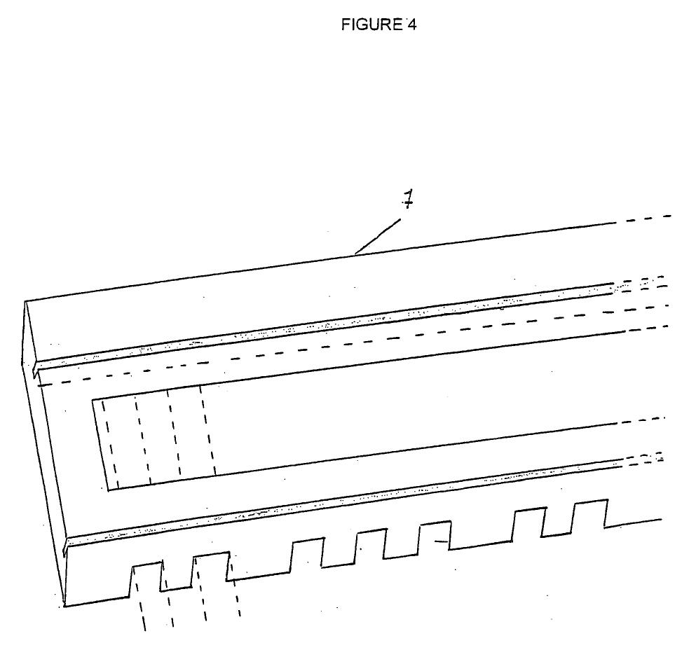

FIG. 4 shows a schematic view of the compensation device of FIG. 3 in a condition not positioned on a keyboard;

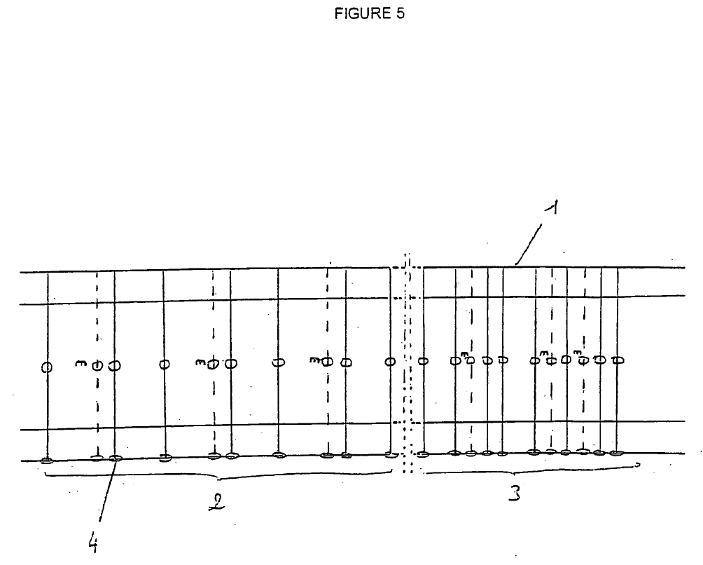

FIG. 5 shows a view from below of a support adapted to be positioned on a keyboard of a piano;

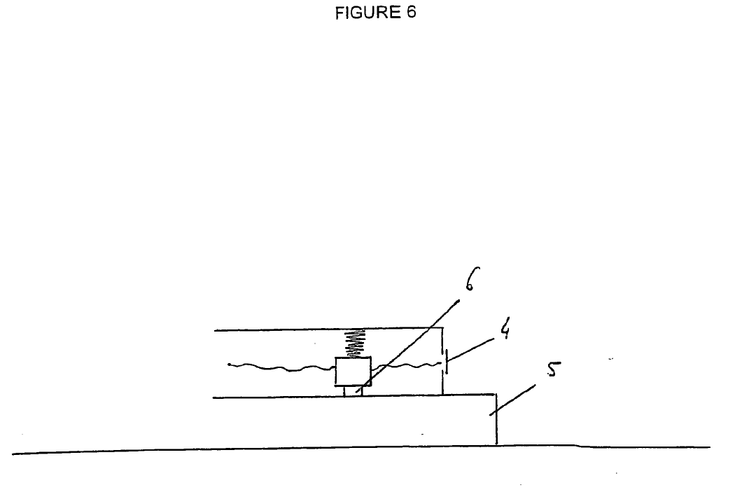

FIG. 6 shows a schematic detailed view in cross-section of the members making up the support in position on a key or the compensation device positioned on the keyboard and

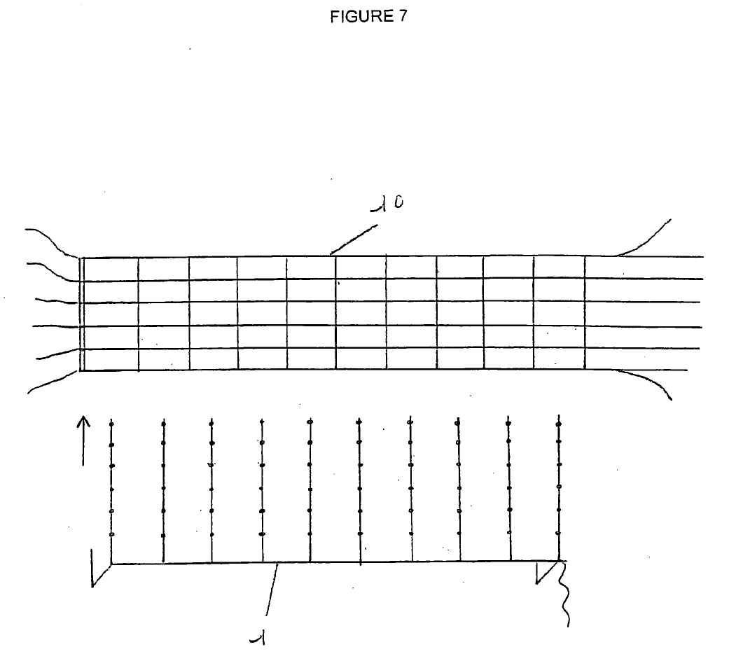

FIG. 7 shows a schematic view of a guitar neck and a device associated with said neck.

The process according to the invention comprises three essential steps.

The first step consists in taking or selecting, on the instrument or on a device associated with the instrument, a note corresponding to the key of the piece to be played and if desired the mode such as minor, major or the like, of this piece.

In a second step, the instrument or the associated device marks or displays, as a function of the keynote and if desired the taken or selected mode, a first range of notes, called melody notes, corresponding to the range of notes permitting to establish a melody.

In a third step, the instrument or associated device displays or marks selectively, as a function of the taken or selected keynote, from the actuated melody note and if desired from the selected mode if this function exists, a series of notes forming a chord corresponding to the note of the actuated melody in the range of permitted notes. This chord may also be called accompaniment. Thus, in the case of an instrument of the type constituted by a keyboard, the melody notes will correspond to the notes played by the right hand of the user whilst the chord notes will correspond to the notes played by the left hand of the user. Thus, when the user will play with the right hand a series of melody notes according to a random order, the corresponding chord will be displayed for each actuated melody note. The user will thus have the possibility of improvising any piece while being able to play simultaneously with both hands, without having any theoretical knowledge of chords.

The determination by the instrument or the device of the melody notes on the one hand and the chord notes on the other hand, can take place by different means. Thus, the instrument or the associated device can determine by computation, from the keynote taken or selected, the notes of the melody and the corresponding chords to be marked or displayed. This determination could take place by computation, particularly from the chromatic scale. This scale is represented in FIG. 1.

The computation principle is the following. The instrument or the associated device selects, from the keynote taken or selected, at least two other notes, the three notes corresponding each to the tonic of a chord. He then selected, from each tonic and as a function if desired of the minor or major mode, the mediant and the dominant of the chord. The notes thus obtained correspond moreover to the permitted range of notes of the melody. He then associates each melody note with one of the three chords containing the melody note, then he determines the placement of the melody notes and the selected chords. The melody notes will thus automatically be displayed or marked whilst the selected chords will not be displayed or marked until after actuation of a melody note and a correspondence to the actuated note.

As seen in FIG. 1, the instrument or associated device selects, from the keynote, two other notes corresponding each respectively to the eighth note before and after the keynote, including the keynote, from the chromatic scale. Thus, in the illustrated example, the keynote selected or taken by the user is do. From this first note, the instrument or associated device determines by computation by using the chromatic scale, that the eighth note disposed before the keynote, if it is included in this figure the keynote itself, is fa, whilst the eighth note disposed after the keynote, if again this keynote is included, is sol. Thus, three notes, namely, fa, do, sol are selected and correspond each to the tonic of a chord. To establish from each tonic the mediant and the dominant of said chord, there is again used the chromatic scale by associating with each tonic, in the case of the major mode, the fifth note disposed before the tonic to identify the mediant then the fourth note from the mediant to identify the dominant. Thus, in the case of a tonic corresponding to fa in the major mode, the mediant and the dominant of said chord are respectively constituted by la and do. In other words, it can also be mentioned that the complete chord, constituted by three notes, is obtained by associating with each tonic the corresponding third and fifth and this in the major mode. Conversely, in the minor mode, there is associated with each tonic the fourth note disposed thereafter on the chromatic scale to determine the mediant, then there is associated with each mediant the fifth note disposed thereafter on the chromatic scale to determine the dominant. Thus, the chords obtained in the minor mode correspond for the tonics and the dominants to the notes obtained in the major mode, whilst the mediant is in the minor mode lowered by a half tone by comparison to the major mode.

From the determination of the chords, there can be established in correspondence the authorized notes of the melody which correspond strictly to those used for the formation of the chords. Thus, in the case of the choice of a keynote corresponding to do, the chords obtained are fa-la-do, do-mi-sol, sol-ti-re. The permitted melody notes will thus be do, re, mi, fa, sol, la, ti. The same demonstration can be carried out in the minor mode. The permitted melody notes being thus do, re, mi flat, fa, sol, la flat, ti flat.

Once the melody and chord notes are determined, the instrument thus associates, with each melody note, a chord. It will be noted that, for certain melody notes adapted to correspond to several chords as shown in FIG. 1, the instrument will select in a predetermined way the corresponding chord.

The placement of the melody notes and the chords can then be determined by the instrument. The melody notes will generally be separated from the selected chords by a number of octaves or intervals.

The process indicated above can thus be reproduced for any keynote. There is thus obtained, in the major mode, a series of chords and accordingly the permitted melody notes represented in FIG. 2, or the key corresponds to the encompassed note selected by the user.

In another mode for determining the melody notes and the chord notes from a keynote, the following process can be used. The instrument or associated device stored in the memory, for each keynote adapted to be taken or selected, the permitted range of the melody notes and the chords corresponding to the actuation of each melody note, are shown in the last line of FIG. 1. He then compares each taken or selected keynote to the stored keynotes. When the result of the comparison is positive, he marks or displays the melody notes stored in correspondence to the stored keynote and during actuation of a melody note, the chord of said melody note. In still another mode of determining the melody notes and the chord notes from a keynote, there is pre-positioned on a device having the form of a support 1, at least two series 2, 3 of members 4 of marking, corresponding, for a predetermined keynote, to one (series 3) to the permitted range of melody notes, the other (series 2) to the chords corresponding to the actuation of each melody note, and in that the support 1 is positioned adjacent the keys or fingerboards 5 of the instrument as a function of the selected keynote.

Finally, in another way of determining the melody notes and the chord notes from a keynote, the chord notes are displayed after analysis of the frequencies of the melody note played.

The instruments for practicing the mentioned method can have a large number of forms. These instruments generally comprise means for taking or selecting a keynote and if desired a minor mode, major mode or the like, first means for marking or displaying, selectively actuable from the taken keynote and if desired of the minor mode, major mode or the like, selected to indicate visually to the user the permitted range of melody notes, and second means for marking or displaying, selectively actuable by actuation of a selected melody note within the permitted range of melody notes, to indicate to the user, upon each actuation of a melody note in the permitted range of notes, the corresponding chord notes. First and second means for marking or display can thus be constituted by luminous display members, such as electroluminescent diodes, each associated with a fingerboard or key of the instrument.

Thus, in the case of an instrument comprising a keyboard with keys, each key is provided with a luminous display member such as a diode. The instrument also comprises means for taking or selecting the keynote. The keynote can particularly be established by means of a frequency analyzer or from a knowledge of the piece to be played or else in a totally random way. When a keynote and if desired the minor mode, major mode or the like, have been taken within the interior of the instrument, the diodes corresponding to the permitted range of melody notes will light up to indicate to the user the notes which can be actuated. From these permitted melody notes, the user can mark each chord by actuation of a melody note. The chord notes are thus provided in the same manner with electroluminescent diodes which light up when a melody note is actuated.

Of course, the determination of the permitted melody notes as well as the corresponding chords could take place either by computation, or from prerecorded data, as has been mentioned above.

In the case of an instrument already equipped in the factory, the first marking means and the second marking or display means could be positioned directly on the keyboard or adjacent the fingerboards in the case of stringed instruments or adjacent the keys in the case particularly of a wind instrument. However, one could also choose to displace particularly the second marking or display means so as to cause the corresponding chord notes to appear no longer directly on the instrument but on any display device such as a screen positioned adjacent the instrument.

The mentioned process can also be practiced by means of a device associated with an instrument. This device associated with the instrument thus comprises means for taking or selecting a keynote and if desired a minor or major mode or the like. It comprises also first means for predetermined marking or display, as a function of the taken or selected keynote, and if desired of the selected mode, to indicate visually to the user a range of melody notes permitted to the instrument, and second means for selectively marking or displaying, actuable by actuation of a melody note selected from the permitted range of melody notes, to indicate to the user the chord corresponding to each melody note played. Again, the first marking or display means can be disposed adjacent the fingerboards or keys of the instrument whilst the same marking or display means are spaced from the instrument, the second means being preferably constituted by a display screen with graphic representations, these representations each corresponding to a chord.

In another embodiment of the device, this latter is constituted, as shown in FIGS. 3 to 6, by a first so-called compensation device 7 shown in FIGS. 3 and 4 positionable on the keyboard 8 of the instrument to fill in the differences of level between the black keys 8A and the white keys 8B and by a support 1, such as a short scale, mounted removably on said keyboard 8 and positioned as a function of the selected keynote. This support 1 comprises at least two series 2, 3 of luminous members 4 corresponding one of them (series 3) to the marking or display means of the permitted range of melody notes, the other one (series 2) to the pre-selected chords, and at least one series of detectors 6 or contacts actuable or respectively de-actuable during pressing a key 8A, 8B of the corresponding keyboard 8 with a permitted melody note. These detectors 6 or contacts are thus coupled to the series 2 of luminous members 4 serving for marking the chords to give rise, during depression of a key 8A, 8B of the keyboard, corresponding to a melody note, the selective actuation of one or several luminous members 4 from the series 2 of luminous members corresponding to the pre-selected chords. When the keynote is modified, it suffices to move the support 1 along the keys 8A, 8B of the keyboard 8 to reposition the selected keynote relative to the corresponding note of the keyboard. In the case in which such a device comprises fingerboards 9 for selection of two modes (minor or major), such a device is particularly simplified because it uses at most two series of luminous members corresponding to the melody notes as a function of the minor or major mode, and two series of luminous members corresponding to the chords as a function of the minor mode or major mode being extended, it being understood that for example, for each series, of luminous members corresponding to the melody notes, there will be a large number of luminous members that are common to the two series. The same is true for the two series of chords. This representation of the series of luminous members is accordingly claim 5. Of course, there can be provided other means of operation than the minor and major modes which will require having new series of luminous members.

This same principle could be repeated for other instruments. Thus, in the case of an application of such a device to a guitar, it will suffice simply to adapt the shape of the support 1 to a guitar body 10 as shown in FIG. 7. The accompaniment could thus be displayed on a screen from the detection of each actuated melody note.

Of course, and as mentioned above, if the device comprises selection means for the minor mode, major mode or the like, these selection means will act on the series of luminous members as a function of the selected mode.

Of course, other more complex embodiments of devices or instruments permitting the practice of the device can also be imagined. Thus, such a process is adaptable to a computer keyboard for which each key of the keyboard can correspond to a musical note. Similarly, the associated device can incorporate a frequency analyzer which directly displays the corresponding chord.

Finally, the process as well as the instrument and the associated device permitting the practice of such a process, can be used by mentally handicapped persons or by deaf persons by adapting particularly the marking means and by associating colors with it.

1. Process to help in musical composition or playing, to play in harmony any melody on an instrument, characterized in that there is taken or selected, on the instrument or on a device associated with the instrument, a note corresponding to the key of the piece to be played, in that the instrument or associated device marks or displays, as a function of the keynote taken or selected, a first range of notes, called melody notes, corresponding to the permitted range of notes to establish a melody, and in that the instrument or associated device displays or marks selectively, as a function of the taken or selected keynote and of the actuated melody note within the permitted range of melody notes, a series of notes forming a chord corresponding to the actuated melody note within the permitted range of notes.

2. Process according to claim 1,
characterized in that there is taken or selected moreover the mode such as the minor mode, major mode or the like, of the piece, and in that the instrument or associated device marks or displays selectively, as a function of the keynote and of the taken or selected mode, the permitted range of melody notes, and as a function of the key, from the selected mode and from the actuated melody note, the corresponding chord.

3. Process according to one of claims 1 and 2,
characterized in that the instrument or associated device determines by computation from the taken or selected keynote, the melody notes and corresponding chords to be marked or displayed.

4. Process according to claim 3,
characterized in that the instrument or associated device selects, from the taken or selected keynote, at least two other notes, the three notes each corresponding to the tonic of a chord, in that it selects from each tonic and as a function if desired of the minor mode, major mode or the like, the median and the dominant of said chord, the notes thus obtained corresponding moreover to the permitted range of melody notes, in that it associates each melody note with one of the three chords, and in that it determines the placement of the melody notes and of the selected chords.

5. Process according to claim 4,
characterized in that the instrument or associated device selects from the keynote two other notes each corresponding respectively to the eighth note before and after the keynote, including the keynote, on the chromatic scale.

6. Process according to one of claims 1 and 2,
characterized in that the instrument or associated device stores in a memory, for each keynote adapted to be taken or selected, the range of permitted melody notes and the chords corresponding to the actuation of each melody note, in that it compares each keynote taken or selected to the stored keynotes and in that, when the result of the comparison is positive, it marks or displays the stored melody notes in correspondence with the corresponding stored keynote and, during actuation, the chord of said melody notes.

7. Process according to one of claims 1 and 2,
characterized in that there is pre-positioned on a device having the form of a support, at least two series of marking members corresponding for a predetermined keynote, one to the permitted range of melody notes, the other to the chords corresponding to the actuation of each melody note, and in that the support is positioned in the neighborhood of the keys or fingerboards of the instrument as a function of the selected keynote.

8. Instrument, particularly for the practice of the process according to one of claims 1 to 7,
characterized in that it comprises means for taking or selecting a keynote and if desired of the minor mode, major mode or the like, first marking or display means selectively actuable from the taken keynote and if desired of the minor mode, major mode or the like selected to indicate visually to the user the permitted range of melody notes, and second marking or display means selectively actuable by actuation of a melody note selected from the permitted range of melody notes to indicate to the user, upon each actuation of a melody note within the permitted range of notes, the corresponding chord notes.

9. Instrument according to claim 8,
characterized in that the first and second marking or display means are constituted by luminous display members such as electroluminescent diodes each associated with a fingerboard or key of the instrument.

10. Device associated with an instrument particularly for the practice of a process according to one of claims 1 to 7,
characterized in that it comprises means for taking or selecting a keynote and if desired the major mode, minor mode or the like, first means for marking or display predetermined as a function of the taken or selected keynote and if desired of the selected mode, to indicate visually to the user a permitted range of melody notes on the instrument, and a second marking or display means selectively actuable by actuation of a melody note selected from the permitted range of notes to indicate to the user the chord corresponding to each melody note played.

11. Device associated with an instrument according to claim 10,
characterized in that the first marking or display means are disposed adjacent the fingerboards or keys of the instrument whilst the second marking or display means are spaced from the instrument, these second means being preferably constituted by a display screen.

12. Device associated with a keyboard instrument with keys according to one of claims 10 and 11,
characterized in that it is constituted by a first device (7) positionable on the keyboard (8) of the instrument to fill in the differences of level between black keys (8A) and white keys (8B) and of a support (1), such as a short rule, mounted removably on said keyboard (8) and positioned as a function of the selected keynote, this support comprising at least two series (2, 3) of luminous members (4) corresponding one of them (3) to the marking or display means of the permitted range of melody notes, the other one (2) to the pre-selected chords, and at least one series of detectors (6) or contactors actuable or respectively de-actuable during depression of a key of the keyboard (8) corresponding to a permitted melody note, these detectors (6) or contactors being coupled to the series of luminous members (4) serving to mark the chords to give rise, during depression of a key of the keyboard corresponding to a permitted melody note, the selective actuation of one or several luminous members (4) of the series (2) of luminous members (4) corresponding to the pre-selected chords.

13. Associated device for an instrument of the keyboard with keys according to claim 12,
characterized in that it comprises means for selecting the minor mode, the major mode or the like, said selection means acting on said series of luminous members as a function of the selected mode.
